(19) United States
(12) Patent Application Publication
(10) Pub. No.: US 2013/0113795 A1
(43) Pub. Date: May 9, 2013

(54) METHOD FOR GENERATING MULTI-VIEW IMAGES FROM A SINGLE IMAGE

(71) Applicant: Peter Wai Ming Tsang, Hong Kong (CN)

(72) Inventor: Peter Wai Ming Tsang, Hong Kong (CN)

(73) Assignee: City University of Hong Kong, Hong Kong (CN)

(21) Appl. No.: 13/809,981

(22) PCT Filed: Jul. 26, 2010
(86) PCT No.: PCT/IB2010/053373

§ 371 Date: Jan. 14, 2013

(51) Int. Cl. H04N 13/04

(52) U.S. Cl. CPC H04N 13/0402
USPC 345/419

(57) ABSTRACT

From only a single two-dimensional source image (20) of a scene, multiple images (28) of the scene are generated, each image from a different viewing direction or angle. For each of the multiple images, a disparity (24) is generated corresponding to the viewing direction and combined with significant pixels (e.g., edge detected pixels) in the source image. The disparity may be filtered (26) (e.g., low-pass filtered) prior to combining with the significant pixels. The multiple images are combined (64) into an integrated image (62) for display, for example, on an autostereoscopic monitor (10). The process can be repeated for multiple related source images to create a video sequence.

### BACKGROUND OF THE INVENTION

1. Technical Field

The present invention generally relates to the generation of multi-view images. More particularly, the present invention relates to the generation of multi-view images from only pixels in a two-dimensional source image.

2. Background Information

Multi-view images are best be known for their three-dimensional effects when viewed with special eyewear. However, the recent emergence of autostereoscopic display has enabled partial reconstruction of a three-dimensional (3-D) object scene to viewers, and without the need of the latter wearing shutter glasses or polarized/anaglyph spectacles. In this approach, an object scene is grabbed by an array of cameras, each oriented at a different optical axis. The outputs of the cameras are then integrated onto a multi-view autostereoscopic monitor.

Despite the effectiveness of the method, setting up the camera array, and synchronizing the optical characteristics (such as zooming, focusing, etc.) of the cameras are extremely tedious. In addition, it is also difficult to store and distribute the multi-channel video information. This has led to a general lack of such 3D content, hence imposing a major bottleneck in commercializing autostereoscopic monitors, or related products such as 3D digital photo frames.

Thus, a need exists for a simpler way to produce multi-view images without the need for a camera array.

### SUMMARY OF THE INVENTION

Briefly, the present invention satisfies the need for a simpler way to produce multi-view images by generating them using only pixels from a source image.

The present invention describes a method of converting a single, static picture into a plurality of images, each synthesizing the projected image of a 3D object scene along a specific viewing direction. The plurality of images simulates the capturing of such images by a camera array. Subsequently, the plurality of images may be rendered and displayed on a monitor, for example, a 3D autostereoscopic monitor. The method of the invention can be implemented as in independent software program executing on a computing unit, or as a hardware processing circuit (such as a FPGA chip). It can be applied to process static pictures which are captured by optical or numerical means.

The present invention provides, in a first aspect, a method of generating multi-view images of a scene. The method comprises obtaining a single two-dimensional source image of a scene, the source image comprising a plurality of source pixels, and automatically generating at least two multi-view images of the scene from only at least some of the plurality of source pixels, each of the at least two multi-view images having a different viewing direction for the scene.

The present invention provides, in a second aspect, a computing unit, comprising a memory, and a processor in communication with the memory for generating a plurality of multi-view images of a scene according to a method. The method comprises obtaining a single two-dimensional source image of a scene, the source image comprising a plurality of source pixels, and automatically generating at least two multi-view images of the scene from only at least some of the plurality of source pixels, each of the at least two multi-view images having a different viewing direction for the scene.

The present invention provides, in a third aspect, at least one hardware chip for generating a plurality of multi-view images of a scene according to a method. The method comprises obtaining a single two-dimensional source image of a scene, the source image comprising a plurality of source pixels, and automatically generating at least two multi-view images of the scene from only at least some of the plurality of source pixels, each of the at least two multi-view images having a different viewing direction for the scene.

The present invention provides, in a fourth aspect, a computer program product for generating multi-view images of a scene, the computer program product comprising a storage medium readable by a processing circuit and storing instructions for execution by the processing circuit for performing a method. The method comprises obtaining a single two-dimensional source image of a scene, the source image comprising a plurality of source pixels, and automatically generating at least two multi-view images of the scene from only at least some of the plurality of source pixels, each of the at least two multi-view images having a different viewing direction for the scene.

These, and other objects, features and advantages of this invention will become apparent from the following detailed description of the various aspects of the invention taken in conjunction with the accompanying drawings.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts an autostereoscopic monitor displaying multi-view images generated according to the method of the present invention.

FIG. 2 is a flow/block diagram for a method of generating a plurality of multi-view images of a scene according to aspects of the present invention.

FIG. 3 is a flow/block diagram for a method of generating a plurality of multi-view images of a scene according to additional aspects of the present invention.

FIG. 4 is a block diagram of one example of a computer program product storing code or logic implementing the method of the present invention.

FIG. 5 is a block diagram of one example of a computing unit storing and executing program code or logic implementing the method of the present invention.

FIG. 6 is a flow/block diagram for one example of the generation of a single image from a plurality of multi-view images in accordance with the present invention.

### DETAILED DESCRIPTION OF THE INVENTION

The present invention converts a single, static picture into a plurality of images, each simulating the projected image of a 3D object scene along a specific viewing direction. For each image created, an offset is generated and added to at least some pixels in the source image. To create a 3D effect, at least two images are needed, each from a different viewing direction. Additional processing may also take place as described below. The plurality of images may then be rendered and displayed.

A plurality of M images, hereafter referred to as the multi-view images, are generated from a single, static two-dimensional image, hereafter refer to as the source image. Let I(x, y) represent the source image, and gᵢ(x, y)|_{0≦i<M} denote the i^{th} multi-view image to be generated. The conversion of I(x, y) to gᵢ(x, y)|_{0≦i<M} can be defined as

gᵢ(x,y)|_{0≦i<M}=I(x+δᵢ)(x,y),y), (1)

where x and y are the horizontal and vertical co-ordinates of the pixel in the source image, respectively. δᵢ(x, y) and Δx are integers, and δᵢ(x, y) is a variable defined in the interval [−Δx, Δx]. δᵢ(x, y) is the disparity or offset between a pixel in the source image I(x, y), and a corresponding pixel in gᵢ(x, y)|_{0≦i<M}.

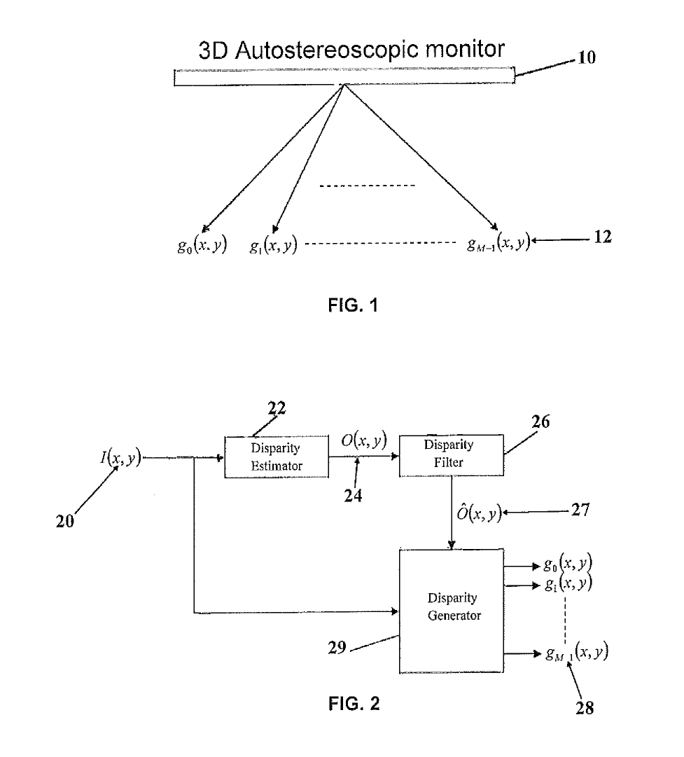

When the multi-view images are displayed on a 3D autostereoscopic monitor, for example, it will generate a three-dimensional perception on the source image I(x, y). More specifically, if the multi-view images are displayed on a 3D autostereoscopic monitor (10, FIG. 1), each image in the sequence of images [g₀(x, y), g₁(x, y), . . . , g_{M-1}(x, y)] 12 will be refracted to a unique angle as shown in FIG. 1.

FIG. 2 is a flow/block diagram for a method of generating a plurality of multi-view images of a scene according to aspects of the present invention. The source image I(x, y) 20 is input into a Disparity Estimator 22 to provide an initial disparity map O(x, y) 24 which is obtained from the weighted sum of the three primary components (or other equivalent representation) of each pixel in I(x, y). Mathematically,

O(x,y)=K+w_{R}R(x,y)+w_{G}G(x,y)+w_{B}B(x,y), (2)

where K is a constant. R(x, y), G(x, y), and B(x, y) are the red, green, and blue values of a pixel located at position (x, y) in the source image I(x, y). w_{R}, w_{G}, and w_{B} are the weighting factors for R(x, y), G(x, y), and B(x, y), respectively. Note that a pixel in the source image can be represented in other equivalent forms, such as the luminance (Y(x, y)) and the chrominance (U(x, y) and V(x, y)) components, each of which can be derived, as one skilled in the art will know, from certain linear or non-linear combinations of R(x, y), G(x, y), and B(x, y).

In one example, K=0 and the three weighting factors are assigned an identical value of ⅓. This means that the three color components are assigned equal weighting in determining the disparity map.

In a second example, the weighting factors are assigned as:

w_{R}=−0.3, w_{G}=−0.59, w_{B}=−0.11,

where K is a positive constant such that O(x, y)≧0 for all pixels in the source image I(x, y). Such a weighting implies that the value of each point in the disparity map is positive, and inversely proportional to the luminance of the corresponding pixel in the source image I(x, y).

In a third example, the constant K and the three weighting factors are adjusted manually, subject to the constraint:

w_{R}+w_{G}+w_{B}=V,

where V is a finite constant which may, for example, be equal to 1. The viewer may determine the weighting according to personal preference on the 3D effect.

In the set of multi-view images, each image is generated by adding the disparity or offset to each pixel in the source image. However, this may result in abrupt changing in the disparity values between pixels within a close neighborhood, hence causing a discontinuity in the 3D perception. To enhance the visual pleasantness of the multi-view images, the initial disparity map may be processed by a Disparity Filter 26, resulting in an enhanced disparity map Ô(x, y) 27. Ô(x, y) may be obtained, for example, by filtering the disparity map O(x, y) with a two-dimensional low-pass filtering function F(x, y). F(x, y) can be any number of low-pass filtering functions, such as a Box or a Hamming filter, but it is understood that F(x, y) can be changed to other functions to adjust the 3D effect. Examples of other functions include, but are not limited to, the Hanning, the Gaussian, and the Blackman lowpass filters. Mathematically, the filtering process can be represented by the convolution between O(x, y) and F(x, y) as

Ô(x,y)=O(x,y)*F(x,y) (3)

The set of multi-view images 28 is generated from the source image and Ô(x, y) (if not filtered, then O(x,y)) with the Disparity Generator 29 according to Eqs. (4.1) and (4.2) below.

Let i denote the i^{th} multi-view image to be generated. If (i≧offset) then

gᵢ(x+m,y)=I(x,y) for 0≦m≦(i−offset)w_{d}Ô(x,y). (4.1)

If (i<offset) then

gᵢ(x+m,y)=I(x,y) for (i−offset)w_{d}Ô(x,y)≦m≦0. (4.2)

where offset is an integer which can be within the range [0,M]. However, it is understood that other ranges are possible and could be manually adjusted by the viewer. w_{d} is a weighting factor which is constant for a given source image I(x, y), and is used to adjust the difference between the multi-view images generated based on Eq. (4.1) and Eq. (4.2). In general, the larger the value of w_{d}, the larger will be the 3D effect. However, if w_{d} is too large, it may degrade the visual quality of the multi-view images. In one embodiment, the range of w_{d} is in within the range

$$[ 0 , \frac{6}{{V}_{max}} ] ,$$

where Vₘₐₓ is a normalizing constant which may be, for example, the maximum luminance intensity of a pixel in the source image I(x, y). However, it is understood that the range can be changed manually to suit personal preference.

Eq. (4.1) and Eq. (4.2) imply that each pixel in gᵢ(x, y) is derived from a pixel in I(x+δᵢ(x, y), y). As such, the disparity term δᵢ(x, y) for each pixel in gᵢ(x, y) is determined in an implicit manner.

In one example, the term (i−offset)w_{d}Ô(x, y) in Eq. (4.1) and Eq. (4.2) can be limited to a maximum and a minimum value, respectively.

In another example, Eq. (4.1) or Eq. (4.2) are applied only once to each pixel in gᵢ(x, y). This ensures that a pixel in gᵢ(x, y) will not be changed if it has been previously assigned to a pixel in I(x, y) with Eq. (4.1) or Eq. (4.2).

The term offset is a pre-defined value which is constant for a given source image. Different source images can have different offset values. The purpose of offset is to impose a horizontal shift on each of the multi-view images, creating the effect as if the observer is viewing the 3D scene, which is generated from the source image, at different horizontal positions.

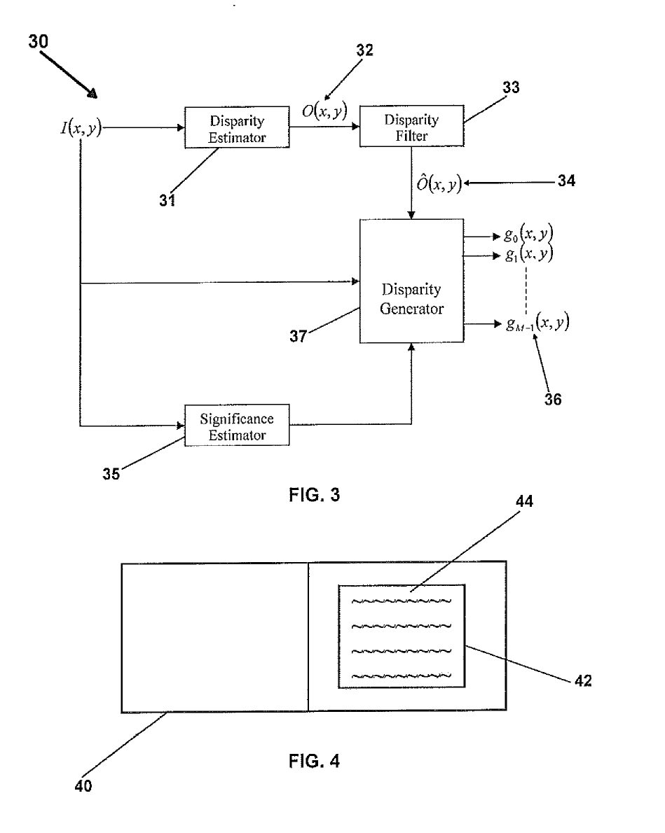

As shown in FIG. 3, according to another aspect of the invention, the source image I(x, y) 30 is input into a Disparity Estimator 31 to provide an initial disparity map O(x, y) 32. Similar to the description of FIG. 2, in the set of multi-view images, each image is generated by adding the disparity to each pixel in the source image. To enhance the visual pleasantness of the multi-view images, the initial disparity map may be processed by a Disparity Filter 33, resulting in an enhanced disparity map Ô(x, y) 34. The source image may also be input into a Significance Estimator 35 to determine the relevance of each pixel in the generation of the multi-view images. The set of multi-view images 36 is generated from Ô(x, y) and the pixels in the source image which exhibit sufficient relevance per the Significance Estimator, with the Disparity Generator 37. The Significance Estimator enhances the speed in generating the multi-view images by excluding some of the pixels that are irrelevant in the generation of the multi-view images, according to predetermined criteria.

In one example, the predetermined criteria for the Significance Estimator takes the form of edge detection, such as a Sobel or a Laplacian operator. The rationale is that 3D perception is mainly imposed by the discontinuity positions in an image. Smooth or homogeneous regions are presumed to have little 3D effect.

The Significance Estimator selects the pixels in the source image I(x, y), which will be processed using Eq. (4.1) and Eq. (4.2) to generate the multi-view images. For the rest of the pixels that are not selected by the Significance Estimator, they will be duplicated in all the multi-view images by, for example, setting the disparity δᵢ(x, y) to zero. In another example, Eq. (4.1) and Eq. (4.2) can be applied only to the pixels in I(x, y) which are selected by the Significance Estimator, hence reducing the computation loading of the entire process. The process of employing the Significance Estimator to generate the multi-view images can be described in the following steps.

Step 1. Set gᵢ(x, y)=I(x, y) for 0≦i<M.

Step 2. If I(x, y) is a significant pixel, then apply Eq. (4.1) and Eq. (4.2) to generate the multi-view images.

Step 1 and step 2 are applied to all the pixels in I(x, y).

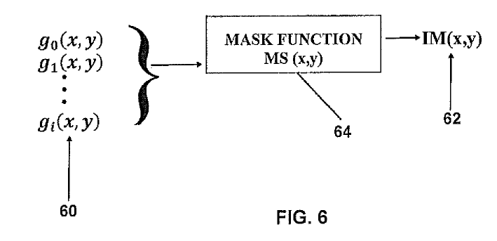

In another aspect of the invention, shown visually in FIG. 6, the set of multi-view images 60 gᵢ(x, y)|_{0≦i<M} are integrated into a single, multi-dimensional image (in the sense of perception), and subsequently displayed on a monitor, for example, an autostereoscopic monitor. For clarity of explanation, the following terminology is adopted.

The integrated image 62, denoted by IM(x, y), is a two dimensional image. Each pixel recording a color is defined by Red (R), Green (G), and Blue (B) values, represented as IM_{R}(x, y), IM_{G}(x, y), and IM_{B}(x, y), respectively.

Each multi-view image, denoted by gᵢ(x, y), is a two dimensional image. Each pixel records a color defined by the Red (R), Green (G), and Blue (B) values, represented as g_{i;R}(x, y), g_{i;G}(x, y), and g_{i;B}(x, y), respectively.

The integration of the multi-view images to the integrated image is achieved in one example for an autostereoscopic monitor, with the use of a two-dimensional mask function 64 MS(x, y). Each entry in MS(x, y) records a triplet of values, each within the range [0,M], and represented as MS_{R}(x, y), MS_{G}(x, y), and MS_{B}(x, y).

The process of converting the multi-view images to IM(x, y) is realized, for example, with the following equations.

IM_{R}(x,y)=g_{i;R}(x,y), (5.1)

where j=MS_{R}(x, y).

IM_{G}(x,y)=g_{m;G}(x,y), (5.2)

where m=MS_{G}(x, y).

IM_{B}(x,y)=g_{n;B}(x,y), (5.3)

where n=MS_{B}(x, y).

The mask function MS(x, y) is dependent on the design of the autostereoscopic monitor which is used to display the integrated image IM(x, y).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “processor,” “circuit,” “system,” or “computing unit.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable signal medium may include a propagated data signal with computer readable program code embodied therein, for example, in baseband or as part of a carrier wave. Such a propagated signal may take any of a variety of forms, including, but not limited to, electro-magnetic, optical or any suitable combination thereof. A computer readable signal medium may be any computer readable medium that is not a computer readable storage medium and that can communicate, propagate, or transport a program for use by or in connection with an instruction execution system, apparatus or device.

A computer readable storage medium may be, for example, but not limited to, an electronic, magnetic, optical, electromagnetic, infrared or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

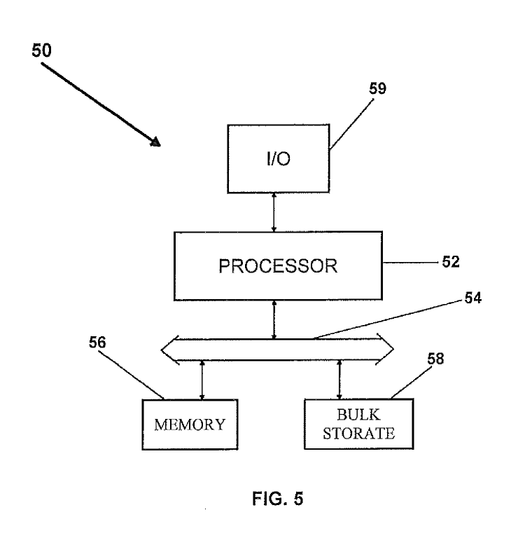

Referring now to FIG. 4, in one example, a computer program product 40 includes, for instance, one or more computer readable storage media 42 to store computer readable program code means or logic 44 thereon to provide and facilitate one or more aspects of the present invention.

Program code embodied on a computer readable medium may be transmitted using an appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language, such as Java, Smalltalk, C++ or the like, and conventional procedural programming languages, such as the “C” programming language, assembler or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Further, a data processing system suitable for storing and/or executing program code is usable that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

As shown in FIG. 5, one example of a computing unit 50 may be provided suitable for storing and/or executing program code is usable that includes at least one processor 52 coupled directly or indirectly to memory elements through a system bus 54. As known in the art, the memory elements include, for instance, data buffers, local memory 56 employed during actual execution of the program code, bulk storage 58, and cache memory which provide temporary storage of at least some program code in order to reduce the number of times code must be retrieved from bulk storage during execution.

Input/Output or I/O devices 59 (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiment with various modifications as are suited to the particular use contemplated.

While several aspects of the present invention have been described and depicted herein, alternative aspects may be effected by those skilled in the art to accomplish the same objectives. Accordingly, it is intended by the appended claims to cover all such alternative aspects as fall within the true spirit and scope of the invention.

### CITATION LIST

Sullivan et al., “2D TO 3D IMAGE CONVERSION,” U.S. Pat. No. 7,573,475, Aug. 11, 2009.
Davidson et al., “INFILLING FOR 2D TO 3D IMAGE CONVERSION,” U.S. Pat. No. 7,573,489, Aug. 11, 2009.
Harmon, “IMAGE CONVERSION AND ENCODING TECHNIQUES FOR DISPLAYING STEREOSCOPIC 3D IMAGES,” U.S. Pat. No. 7,551,770, Jun. 23, 2009.
Harmon, “IMAGE CONVERSION AND ENCODING TECHNIQUES,” U.S. Pat. No. 7,054,478, May 30, 2006.
Naske et al., “METHODS AND SYSTEMS FOR 2D/3D IMAGE CONVERSION AND OPTIMIZATION,” U.S. Pat. No. 7,254,265, Aug. 7, 2007.
Yamashita et al., “DEVICE AND METHOD FOR CONVERTING TWO-DIMENSIONAL VIDEO TO THREE-DIMENSIONAL VIDEO,” U.S. Pat. No. 7,161,614, Jan. 9, 2007.

1. A method of generating a plurality of multi-view images of a scene, the method comprising:
obtaining a single two-dimensional source image of a scene, the source image comprising a plurality of source pixels (20); and
automatically generating at least two multi-view images (28) of the scene from only at least some of the plurality of source pixels, each of the at least two multi-view images having a different viewing direction for the scene.

2. The method of claim 1, further comprising combining (64) the at least two multi-view images (60) into a single integrated image of the scene (62).

3. The method of claim 2, further comprising displaying the single integrated image on a display (10).

4. The method of claim 3, wherein the display comprises an autostereoscopic monitor.

5. The method of claim 1, wherein the automatically generating comprises, for each of the at least two multi-view images (28), generating a disparity (24) for each of the at least some of the plurality of source pixels.

6. The method of claim 5, wherein the disparity comprises weighted values for each of red, blue and green colors.

7. The method of claim 5, wherein the automatically generating further comprises, for each of the at least two multi-view images (28), combining (29) the disparity with each of the at least some of the plurality of source pixels.

8. The method of claim 7, wherein the automatically generating further comprises, prior to the combining, filtering (26) to create a filtered disparity (27), and wherein the combining comprises combining the filtered disparity with each of the at least some of the plurality of source pixels (20).

9. The method of claim 8, wherein the filtering comprises low-pass filtering.

10. The method of claim 1, wherein the automatically generating comprises identifying (35) the at least some of the plurality of source pixels as having at least a predetermined level of relevance.

11. The method of claim 10, wherein the identifying comprises edge detection.

12. The method of claim 1, further comprising repeating the obtaining and the automatically generating for a series of related images of the scene to create a video sequence.

13. A computing unit (50), comprising:
a memory (56); and
a processor (52) in communication with the memory for generating a plurality of multi-view images of a scene according to the method of claim 1.

14. At least one hardware chip for generating a plurality of multi-view images of a scene according to the method claim 1.

15. The at least one hardware chip of claim 14, wherein the at least one hardware chip comprises a Field Programmable Gate Array chip.

16. A computer program product (40) for generating multi-view images of a scene, the computer program product comprising a storage medium (42) readable by a processing circuit and storing instructions (44) for execution by the processing circuit for performing a method according to claim 1.
